(19) United States
(12) Patent Application Publication
(10) Pub. No.: US 2021/0158803 A1
(43) Pub. Date: May 27, 2021

(54) DETERMINING WAKE WORD STRENGTH

(71) Applicant: LENOVO (Singapore) PTE. LTD., New Tech Park (SG)

(72) Inventors: Ryan Charles Knudson, Tampa, FL (US); Roderick Echols, Chapel Hill, NC (US); Russell Speight VanBlon, Raleigh, NC (US); Jonathan Gaither Knox, Morrisville, NC (US)

(21) Appl. No.: 16/691,070

(22) Filed: Nov. 21, 2019

(51) Int. Cl. G10L 15/187; G10L 15/22

(52) U.S. Cl. CPC G10L 15/187; G10L 2015/088; G10L 15/22

(57) ABSTRACT

Apparatuses, methods, systems, and program products are disclosed for determining wake word strength. An apparatus includes a processor and a memory that stores code executable by the processor. The code is executable by the processor to select a language model for a potential wake word based on a determined language for the potential wake word. The potential wake word is intended to activate a device. The code is executable by the processor to compare a phonetic signature of the potential wake word with phonetic signatures of model words in the language model to determine a likelihood of occurrence of one or more of the model words based on the potential wake word and provide an indication of a strength of the potential wake word based on the likelihood of occurrence of one or more of the model words.

### FIELD

The subject matter disclosed herein relates to wake words and more particularly relates to determining a strength of a wake word.

### BACKGROUND

Wake words may be used to wake a device from a dormant state. Some wake words, however, may sound similar to words or phrases spoken during everyday conversations such that the device is unintentionally awakened from a dormant state when a word or phrase that sounds similar to a wake word is detected.

### BRIEF SUMMARY

Apparatuses, methods, systems, and program products are disclosed for determining wake word strength. An apparatus, in one embodiment, includes a processor and a memory that stores code executable by the processor. In certain embodiments, the code is executable by the processor to select a language model for a potential wake word based on a determined language for the potential wake word. The potential wake word is intended to activate a device. In various embodiments, the code is executable by the processor to compare a phonetic signature of the potential wake word with phonetic signatures of model words in the language model to determine a likelihood of occurrence of one or more of the model words based on the potential wake word and provide an indication of a strength of the potential wake word based on the likelihood of occurrence of one or more of the model words.

A method for determining wake word strength, in one embodiment, includes selecting, by a processor, a language model for a potential wake word based on a determined language for the potential wake word. The potential wake word is intended to activate a device. The method, in one embodiment, includes comparing a phonetic signature of the potential wake word with phonetic signatures of model words in the language model to determine a likelihood of occurrence of one or more of the model words based on the potential wake word and providing an indication of a strength of the potential wake word based on the likelihood of occurrence of one or more of the model words.

A computer program product for determining wake word strength, in one embodiment, includes a computer readable storage medium having program instructions embodied therewith. In certain embodiments, the program instructions are executable by a processor to cause the processor to select a language model for a potential wake word based on a determined language for the potential wake word. The potential wake word is intended to activate a device. In further embodiments, the program instructions are executable by a processor to cause the processor to compare a phonetic signature of the potential wake word with phonetic signatures of model words in the language model to determine a likelihood of occurrence of one or more of the model words based on the potential wake word and provide an indication of a strength of the potential wake word based on the likelihood of occurrence of one or more of the model words.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a system for determining wake word strength;

FIG. 2 is a schematic block diagram illustrating one embodiment of an apparatus for determining wake word strength;

FIG. 3 is a schematic block diagram illustrating one embodiment of another apparatus for determining wake word strength;

FIG. 4 is a schematic flow chart diagram illustrating one embodiment of a method for determining wake word strength; and

FIG. 5 is a schematic flow chart diagram illustrating one embodiment of another method for determining wake word strength.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

An apparatus, in one embodiment, includes a processor and a memory that stores code executable by the processor. In certain embodiments, the code is executable by the processor to select a language model for a potential wake word based on a determined language for the potential wake word. The potential wake word is intended to activate a device. In various embodiments, the code is executable by the processor to compare a phonetic signature of the potential wake word with phonetic signatures of model words in the language model to determine a likelihood of occurrence of one or more of the model words based on the potential wake word and provide an indication of a strength of the potential wake word based on the likelihood of occurrence of one or more of the model words.

In one embodiment, the code is further executable by the processor to receive the potential wake word while the device is in a setup mode. In further embodiments, the potential wake word comprises a spoken word or phrase from a user that is received via a microphone.

In one embodiment, the code is further executable by the processor to determine the language for the potential wake word based on a language analysis of the potential wake word. In certain embodiments, the code is further executable by the processor to select a general language model as the language model in response to the language of the potential wake word not being determinable.

In one embodiment, the strength of the potential wake word comprises a quantitative value determined based on a frequency of occurrence of one or more of the model words that are phonetically similar to the potential wake word. The quantitative value may include one or more of a score, a rank, and a percentage.

In one embodiment, the provided indication comprises an audio indication of the strength of the potential wake word. The audio indication may include one of an audio message and a number of beeps. In further embodiments, the provided indication comprises a visual indication of the strength of the potential wake word. The visual indication may include one or more of presenting a text message and/or an image on a display and/or presenting a light pattern and/or a light color using one or more lights on the device.

In certain embodiments, the code is further executable by the processor to set the potential wake word as an active wake word for the device in response to the strength of the potential wake word satisfying a threshold strength. In further embodiments, the code is further executable by the processor to prevent the potential wake word from being used as an active wake word for the device in response to a strength of the potential wake word not satisfying a threshold strength. In one embodiment, the code is further executable by the processor to allow the potential wake word to be used as an active wake word for the device in response to receiving input from a user to override prevention of the use of the potential wake word.

In some embodiments, the code is further executable by the processor to determine and provide one or more suggestions for different potential wake words based on the potential wake word and one or more of the model words that are likely to occur based on the potential wake word. In some embodiments, the code is further executable by the processor to provide the one or more model words that are likely to occur based on the potential wake word.

A method for determining wake word strength, in one embodiment, includes selecting, by a processor, a language model for a potential wake word based on a determined language for the potential wake word. The potential wake word is intended to activate a device. The method, in one embodiment, includes comparing a phonetic signature of the potential wake word with phonetic signatures of model words in the language model to determine a likelihood of occurrence of one or more of the model words based on the potential wake word and providing an indication of a strength of the potential wake word based on the likelihood of occurrence of one or more of the model words.

In one embodiment, the method includes receiving the potential wake word while the device is in a setup mode. The potential wake word includes a spoken word or phrase from a user that is received via a microphone. In one embodiment, the method includes determining the language for the potential wake word based on a language analysis of the potential wake word, and in response to the language of the potential wake word not being determinable, selecting a general language model as the language model.

In one embodiment, the strength of the potential wake word comprises a quantitative value determined based on a frequency of occurrence of one or more of the model words that are phonetically similar to the potential wake word. The quantitative value may include one or more of a score, a rank, and a percentage.

In one embodiment, the method includes setting the potential wake word as an active wake word for the device in response to the strength of the potential wake word satisfying a threshold strength. In further embodiments, the method includes determining and providing one or more suggestions for different potential wake words based on the potential wake word and one or more of the model words that are likely to occur based on the potential wake word.

A computer program product for determining wake word strength, in one embodiment, includes a computer readable storage medium having program instructions embodied therewith. In certain embodiments, the program instructions are executable by a processor to cause the processor to select a language model for a potential wake word based on a determined language for the potential wake word. The potential wake word is intended to activate a device. In further embodiments, the program instructions are executable by a processor to cause the processor to compare a phonetic signature of the potential wake word with phonetic signatures of model words in the language model to determine a likelihood of occurrence of one or more of the model words based on the potential wake word and provide an indication of a strength of the potential wake word based on the likelihood of occurrence of one or more of the model words.

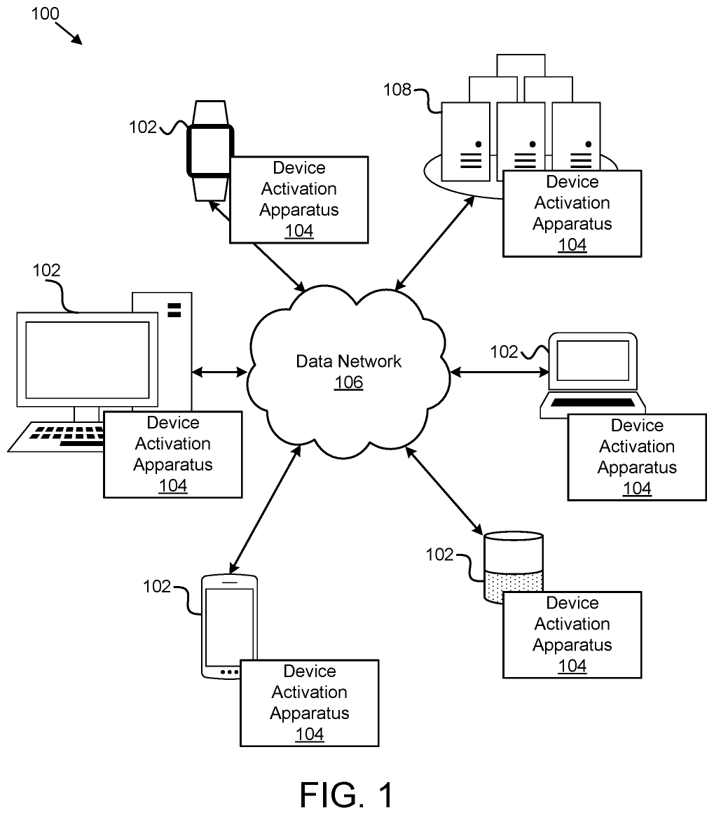

FIG. 1 is a schematic block diagram illustrating one embodiment of a system 100 for determining wake word strength. In one embodiment, the system 100 includes one or more information handling devices 102, one or more device activation apparatuses 104, one or more data networks 106, and one or more servers 108. In certain embodiments, even though a specific number of information handling devices 102, device activation apparatuses 104, data networks 106, and servers 108 are depicted in FIG. 1, one of skill in the art will recognize, in light of this disclosure, that any number of information handling devices 102, device activation apparatuses 104, data networks 106, and servers 108 may be included in the system 100.

In one embodiment, the system 100 includes one or more information handling devices 102. The information handling devices 102 may include one or more of a desktop computer, a laptop computer, a tablet computer, a smart phone, a smart speaker (e.g., Amazon Echo®, Google Home®, Apple HomePod®), an Internet of Things device, a security system, a set-top box, a gaming console, a smart TV, a smart watch, a fitness band or other wearable activity tracking device, an optical head-mounted display (e.g., a virtual reality headset, smart glasses, or the like), a High-Definition Multimedia Interface (“HDMI”) or other electronic display dongle, a personal digital assistant, a digital camera, a video camera, or another computing device comprising a processor (e.g., a central processing unit (“CPU”), a processor core, a field programmable gate array (“FPGA”) or other programmable logic, an application specific integrated circuit (“ASIC”), a controller, a microcontroller, and/or another semiconductor integrated circuit device), a volatile memory, and/or a non-volatile storage medium, a display, a connection to a display, and/or the like.

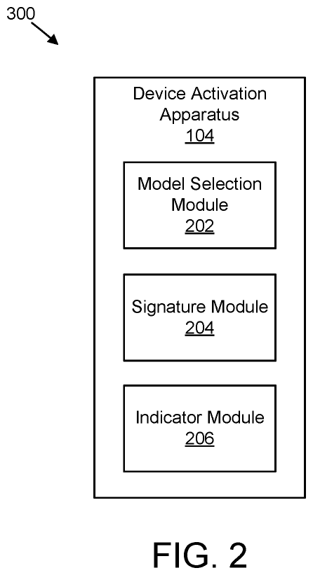

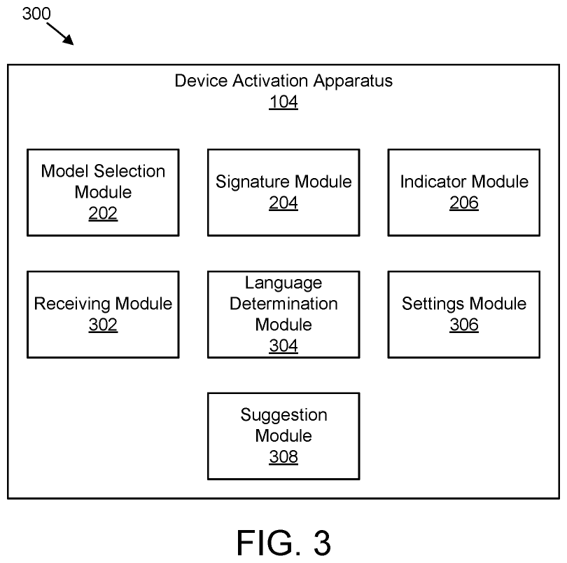

In one embodiment, the device activation apparatus 104 is configured to select a language model for a potential wake word based on a determined language for the potential wake word, compare a phonetic signature of the potential wake word with phonetic signatures of model words in the language model to determine a likelihood of occurrence of one or more of the model words in response to the potential wake word, and provide an indication of a strength of the potential wake word based on the likelihood of occurrence of one or more of the model words in response to the potential wake word. In this manner, the likelihood that a potential wake word may trigger false positives for activating a device can be determined and indicated to a user. The device activation apparatus 104, including its various sub-modules, may be located on one or more information handling devices 102 in the system 100, one or more servers 108, one or more network devices, and/or the like. The device activation apparatus 104 is described in more detail below with reference to FIGS. 2 and 3.

In various embodiments, the device activation apparatus 104 may be embodied as a hardware appliance that can be installed or deployed on an information handling device 102, on a server 108, on a user's mobile device, on a display, or elsewhere on the data network 106. In certain embodiments, the device activation apparatus 104 may include a hardware device such as a secure hardware dongle or other hardware appliance device (e.g., a set-top box, a network appliance, or the like) that attaches to a device such as a laptop computer, a server 108, a tablet computer, a smart phone, a security system, or the like, either by a wired connection (e.g., a universal serial bus (“USB”) connection) or a wireless connection (e.g., Bluetooth®, Wi-Fi, near-field communication (“NFC”), or the like); that attaches to an electronic display device (e.g., a television or monitor using an HDMI port, a DisplayPort port, a Mini DisplayPort port, VGA port, DVI port, or the like); and/or the like. A hardware appliance of the device activation apparatus 104 may include a power interface, a wired and/or wireless network interface, a graphical interface that attaches to a display, and/or a semiconductor integrated circuit device as described below, configured to perform the functions described herein with regard to the device activation apparatus 104.

The device activation apparatus 104, in such an embodiment, may include a semiconductor integrated circuit device (e.g., one or more chips, die, or other discrete logic hardware), or the like, such as a field-programmable gate array (“FPGA”) or other programmable logic, firmware for an FPGA or other programmable logic, microcode for execution on a microcontroller, an application-specific integrated circuit (“ASIC”), a processor, a processor core, or the like. In one embodiment, the device activation apparatus 104 may be mounted on a printed circuit board with one or more electrical lines or connections (e.g., to volatile memory, a non-volatile storage medium, a network interface, a peripheral device, a graphical/display interface, or the like). The hardware appliance may include one or more pins, pads, or other electrical connections configured to send and receive data (e.g., in communication with one or more electrical lines of a printed circuit board or the like), and one or more hardware circuits and/or other electrical circuits configured to perform various functions of the device activation apparatus 104.

The semiconductor integrated circuit device or other hardware appliance of the device activation apparatus 104, in certain embodiments, includes and/or is communicatively coupled to one or more volatile memory media, which may include but is not limited to random access memory (“RAM”), dynamic RAM (“DRAM”), cache, or the like. In one embodiment, the semiconductor integrated circuit device or other hardware appliance of the device activation apparatus 104 includes and/or is communicatively coupled to one or more non-volatile memory media, which may include but is not limited to: NAND flash memory, NOR flash memory, nano random access memory (nano RAM or “NRAM”), nanocrystal wire-based memory, silicon-oxide based sub-10 nanometer process memory, graphene memory, Silicon-Oxide-Nitride-Oxide-Silicon (“SONOS”), resistive RAM (“RRAM”), programmable metallization cell (“PMC”), conductive-bridging RAM (“CBRAM”), magneto-resistive RAM (“MRAM”), dynamic RAM (“DRAM”), phase change RAM (“PRAM” or “PCM”), magnetic storage media (e.g., hard disk, tape), optical storage media, or the like.

The data network 106, in one embodiment, includes a digital communication network that transmits digital communications. The data network 106 may include a wireless network, such as a wireless cellular network, a local wireless network, such as a Wi-Fi network, a Bluetooth® network, a near-field communication (“NFC”) network, an ad hoc network, and/or the like. The data network 106 may include a wide area network (“WAN”), a storage area network (“SAN”), a local area network (“LAN”), an optical fiber network, the internet, or other digital communication network. The data network 106 may include two or more networks. The data network 106 may include one or more servers, routers, switches, and/or other networking equipment. The data network 106 may also include one or more computer readable storage media, such as a hard disk drive, an optical drive, non-volatile memory, RAM, or the like.

The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a Bluetooth® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (ASTM®), the DASH7™ Alliance, and EPCGlobal™.

Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT+® connection as defined by Dynastream® Innovations Inc. of Cochrane, Canada.

The wireless connection may be an infrared connection including connections conforming at least to the Infrared Physical Layer Specification (“IrPHY”) as defined by the Infrared Data Association® (“IrDA”®). Alternatively, the wireless connection may be a cellular telephone network communication. All standards and/or connection types include the latest version and revision of the standard and/or connection type as of the filing date of this application.

The one or more servers 108, in one embodiment, may be embodied as blade servers, mainframe servers, tower servers, rack servers, and/or the like. The one or more servers 108 may be configured as mail servers, web servers, application servers, FTP servers, media servers, data servers, web servers, file servers, virtual servers, and/or the like. The one or more servers 108 may be communicatively coupled (e.g., networked) over a data network 106 to one or more information handling devices 102. The servers 108 may be configured to perform speech analysis, speech processing, natural language processing, or the like, and may store one or more language models that may be used for language analysis and compare as it relates to the subject matter disclosed herein.

FIG. 2 is a schematic block diagram illustrating one embodiment of an apparatus 200 for determining wake word strength. In one embodiment, the apparatus 200 includes an instance of a device activation apparatus 104. The device activation apparatus 104, in certain embodiments, includes one or more of a model selection module 202, a signature module 204, and an indicator module 206, which are described in more detail below.

The model selection module 202, in one embodiment, is configured to select a language model for a potential wake word based on a determined language for the potential wake word. A wake word, as used herein, comprises a word or a phrase (e.g., a string or plurality of words) that activates a dormant device when spoken by a user or otherwise audibly detected by the device. For example, “Alexa” or “OK Google” may be default wake words for smart devices such as smart speakers, smart televisions, smart phones, or the like that enable virtual assistants or intelligent personal assistant services by Amazon® or Google®. The devices may be configured to actively “listen” for the wake word using sensors such as a microphone.

In certain embodiments, smart devices allow users to create their own wake words in addition to, or in place of, a default wake word. The model selection module 202, upon detecting a potential wake word at a device, e.g., using a microphone for the device, determines, selects, references, checks, or the like a language model based on the determined language of the potential wake word. As used herein, a language model may refer to a probability distribution model for sequences of words. The language model may provide context to distinguish between words and/or phrases that sound similar. The language model may be a natural language processing model, a phonetic language model (e.g., a language model based on the sounds of the words/phrases), and/or the like. Language models may exist for various languages, combinations of languages, and/or may be a general language model such as the Carnegie Mellon University Pronouncing Dictionary (which contains words and their corresponding pronunciations).

As described in more detail below, the language of the potential wake word may be determined and used to select a language model for analyzing the potential wake word. The model selection module 202 may maintain or reference a list of possible language models that can be used to analyze the potential wake word. The language models may be stored locally or in a remote location such as on a cloud server or other remote location that is accessible over the data network 106.

The signature module 204, in one embodiment, is configured to compare a phonetic signature of the potential wake word with phonetic signatures of model words in the language model to determine a likelihood of occurrence of one or more of the model words based on the potential wake word. The signature module 204, for instance, may input the potential wake word (e.g., a text form of the potential wake word) into a natural language process or other artificial intelligence/machine learning process that uses the selected language model to determine a probability, percentage, score, rank, or other value that indicates the likelihood that the potential wake word is similar to one or more other words or phrases in the language model, which indicates the likelihood that the potential wake word may be unintentionally triggered in response to a user saying one or more of the model wake words/phrases during normal conversation.

For instance, the signature module 204 may determine a probability, based on output from the language model, that one or more of the model words/phrases is likely to trigger the potential wake word. For example, a potential wake word such as “Mike Tyson” may be triggered by a phrase such as “my dyson” or the potential wake word “recognize speech” may be triggered by a phrase “wreck a nice beach”, and so on. The signature module 204 may utilize the language model to determine (1) a likelihood or probability that the potential wake word sounds similar (e.g., is phonetically similar) to words/phrases in the language model and (2) the frequency with which the similar-sounding model words/phrases are used in the determined language (e.g., the probability distribution of the similar-sounding model words/phrases).

If the likelihood that the potential wake word sounds similar to one or more words/phrases in the language model is less than a threshold probability, e.g., less than 5%, then the potential wake word may be a good candidate to be the wake word for the device. Otherwise, if the likelihood that the potential wake word sounds similar to one or more words/phrases in the language model is greater than or equal to a threshold probability, e.g., greater than 5%, then the signature module 204 may further determine the frequency with which the similar-sounding words/phrases are used in everyday conversations.

If the frequency of use of a similar-sounding model word/phrase is below a threshold, e.g., less than 5%, then the potential wake word may be a usable candidate for the wake word of a device even if it sounds similar to one or more model words/phrases. Otherwise, if the frequency of use of a similar-sounding model word is greater than or equal to a threshold, e.g., 50%, then the potential wake word may not be a good candidate for the wake word for the device. Frequencies of use between the lower threshold and the upper threshold may indicate that the potential wake word can be used, but it may occasionally be triggered by certain words/phrases.

In one embodiment, the indicator module 206 provides an indication of the strength of the potential wake word based on the likelihood of occurrence of one or more of the model words. The strength of the potential wake word, in certain embodiments, is an indication of how likely the potential wake word is to be triggered by every day, normal conversations, which, as explained above, is determined based on the phonetic similarity of the potential wake word to words/phrases in the language model and/or the frequency of occurrence of one or more of the model words that are phonetically similar to the potential wake word.

For example, as discussed above, if the potential wake word is not phonetically similar to other words/phrases in the language model (e.g., if the likelihood that the potential wake word sounds similar to a different word/phrase in the language model is less than a threshold value), then the potential wake word may be a strong candidate to use as the wake word for the device, which the indicator module 206 may indicate to the user. Similarly, if the potential wake word is phonetically similar to a model word, but the frequency of use of the model word/phrase is less than a threshold value, then the potential wake word may still be a good candidate to use as the wake word for the device.

On the other hand, if the potential wake word is phonetically similar to other words/phrases in the language model (e.g., if the likelihood that the potential wake word sounds similar to a different word/phrase in the language model is greater than or equal to a threshold value), and/or if the similar model words/phrases occur at a frequency that is greater than or equal to a threshold value, then the strength of the potential wake word may be low, indicating that it is not a good candidate to be used as the wake word for a device.

The indicator module 206, in certain embodiments, converts or normalizes the likelihood or probability that the potential wake word is phonetically similar to a model word/phrase and/or the frequency with which the model words/phrases are used to a quantitative value representing the strength of the potential wake word that can be presented to a user or otherwise provided as feedback. The indicator module 206, for instance, may calculate a score, a rank, a percentage, and/or some other relative value that can be used on a bounded scale. Furthermore, the indicator module 206 may determine or establish ranges that indicate a relative strength of the potential wake word according to the probability or likelihood values that the language model generates based on the potential wake word.

For example, if the language model determines that there is a 40% likelihood that the potential wake word will be triggered by a different word/phrase, the indicator module 206 may translate this to a strength scale of 1-5, where each number 1, 2, 3, 4, 5, represents a probability range of 20% and where 5 is the strongest and 1 is the weakest, such that a 40% likelihood rating corresponds to a 4 on the scale (5 corresponding to 0-20%, 4 corresponding to 21-40%, and so on). Other scales, factors, and ranges may be used.

The indicator module 206 may use the determined strength to audibly or visually indicate to a user the strength of the potential wake word. For instance, certain devices may include lights and the indicator module 206 may trigger a series of light pulses to indicate the strength of the potential wake word, e.g., three pulses for a strength rating of three out of five or the indicator module 206 may set a color for the light such as red indicating that the potential wake word is weak, yellow indicating that the potential wake word is neither strong nor weak, and green indicating that the potential wake word is strong.

The indicator module 206, in certain embodiments, provides a visual or textual indication of the strength of the potential wake word on a display of the device. An image may include, for example, the quantitative rank of the strength of the potential wake word on a visual scale from 1 to 10, or the text may include a display of the percentage strength of the potential wake word (e.g., 75% strength).

In further embodiments, the device may include speakers that the indicator module 206 can use to audibly indicate the strength of the potential wake word. For instance, the indicator module 206 may output the percentage strength or scaled rank of the potential wake word to a speaker of a smart device that the potential wake word is intended for so that it is audibly presented via the speaker, e.g., as a number of beeps (e.g., 3 beeps indicates a 3 out of 5), as a computer-generated voice, or the like.

In this manner, the device activation apparatus 104 can dynamically provide feedback to a user regarding the strength of a potential wake word based on a statistical analysis of the potential wake word using a language model for the language of the potential wake word. This provides a user with quantitative data for deciding whether a potential wake word is a good candidate for a wake word for a device or whether and/or how often the potential wake word will be triggered by normal, everyday conversations that occur within a proximity (e.g., within listening distance) of the device.

FIG. 3 is a schematic block diagram illustrating one embodiment of another apparatus 300 for determining wake word strength. In one embodiment, the apparatus 300 includes an instance of a device activation apparatus 104. The device activation apparatus 104, in certain embodiments, includes one or more of a model selection module 202, a signature module 204, and an indicator module 206, which may be substantially similar to the model selection module 202, the signature module 204, and the indicator module 206 described above with reference to FIG. 2. In further embodiments, the device activation apparatus 104 includes one or more of a receiving module 302, a language determination module 304, a settings module 306, and a suggestion module 308, which are described in more detail below.

The receiving module 302 is configured to receive the potential wake word while the device is in a setup mode. For instance, as described above, the device may allow a user to set or create their own wake word. In such an embodiment, the device may be placed in a setup or training mode such that the receiving module 302 is listening for the potential wake word, e.g., after providing a prompt to the user to provide the potential wake word, and may capture any audible words/phrases using the microphone on the device.

In one embodiment, in response to the receiving module 302 receiving the potential wake word, the language determination module 304 determines the language of the received potential wake word (e.g., English, Spanish, or the like), which the model selection module 202 uses to select a language model for analyzing the potential wake word, as described above. The language determination module 304, in certain embodiments, uses natural language processing or the like to analyze the potential wake word and determine what language, or combination of languages the potential wake word is spoken in.

For instance, the receiving module 302 may transcribe the received potential wake word, may determine a language signature of the potential wake word and/or the like, which the language determination module 304 may use as input into a natural language engine or for comparison with dictionaries in different languages to determine which the language of the potential wake word and/or a probability that the potential wake word was spoken in a certain language.

In one embodiment, if the language determination module 304 cannot determine the language of the potential wake word, the model selection module 202 selects a default or general language model (e.g., the Carnegie Mellon University Pronouncing Dictionary) for analyzing the potential wake word. In further embodiments, the model selection module 202 selects a language model that corresponds to the language that the language determination module 304 determines with the highest confidence.

For example, the language determination module 304 may not be able to determine with 100% accuracy the language of the potential wake word but may determine with 40% accuracy that it is English, 30% accuracy that it is Spanish, and so on. In such an embodiment, the model selection module 202 selects a language model that corresponds to the language with the highest accuracy or confidence.

The settings module 306, in one embodiment, is configured to set the potential wake word as an active wake word for the device in response to the strength of the potential wake word satisfying a threshold strength, e.g., greater than or equal to 75% strength. In other embodiments, the settings module 306 is configured to prevent the potential wake word from being used as an active wake word for the device in response to a strength of the potential wake word not satisfying a threshold strength, e.g., less than 75% strength.

In such an embodiment, the settings module 306 prompts the user for a new potential wake word. In some embodiments, the settings module 306 prompts the user to override the prevention of the use of the potential (weak) wake word so that the potential wake work can be used as an active wake word for the device even though its strength does not satisfy the threshold strength. In certain embodiments, the settings module 206 presents (audibly or visually) the words/phrases from the language model that are likely to trigger the potential wake word so that the user can determine whether the override the prevention of the potential wake word based on the model words/phrases that are likely to occur based on the potential wake word.

In one embodiment, the suggestion module 308 is configured to provide one or more suggestions for different potential wake words based on the potential wake word and one or more of the model words/phrases that are likely to occur based on the potential wake word. For instance, based on the potential wake word, the suggestion module 308 may suggest words or phrases from the language model that occur with a frequency that is less than a threshold frequency (e.g., less than 3%). In other embodiments, the suggestion module 308 may suggest wake words that have been predetermined to be strong wake words or may suggest wake words from different languages than the user's native language, and/or the like. The suggestions may be visually or audibly presented to the user, and the user can confirm use of one or more of the suggested wake words as active wake words for the device.

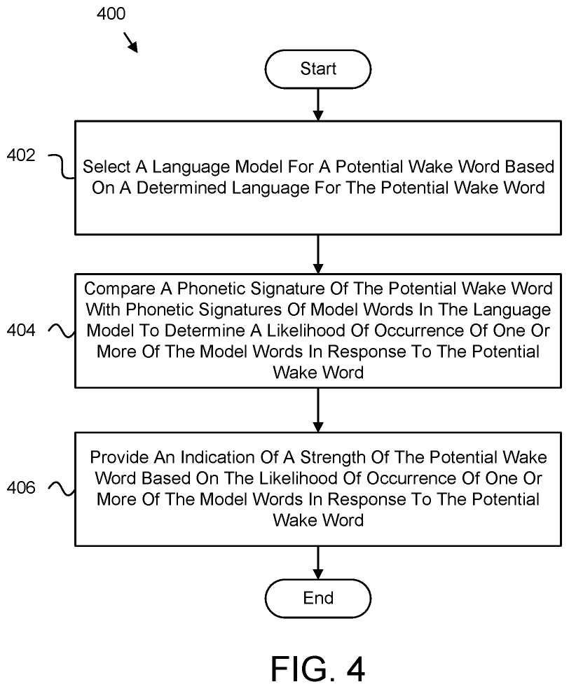

FIG. 4 is a schematic flow chart diagram illustrating one embodiment of a method 400 for determining wake word strength. In one embodiment, the method 400 begins and selects 402 a language model for a potential wake word based on a determined language for the potential wake word. The potential wake word is intended to activate a device. In further embodiments, the method 400 compares 404 a phonetic signature of the potential wake word with phonetic signatures of model words in the language model to determine a likelihood of occurrence of one or more of the model words based on the potential wake word. The method 400, in some embodiments, provides an indication of a strength of the potential wake word based on the likelihood of occurrence of one or more of the model words, and the method 400 ends. In one embodiment, the model selection module 202, the signature module 204, and the indicator module 206 perform the various steps of the method 400.

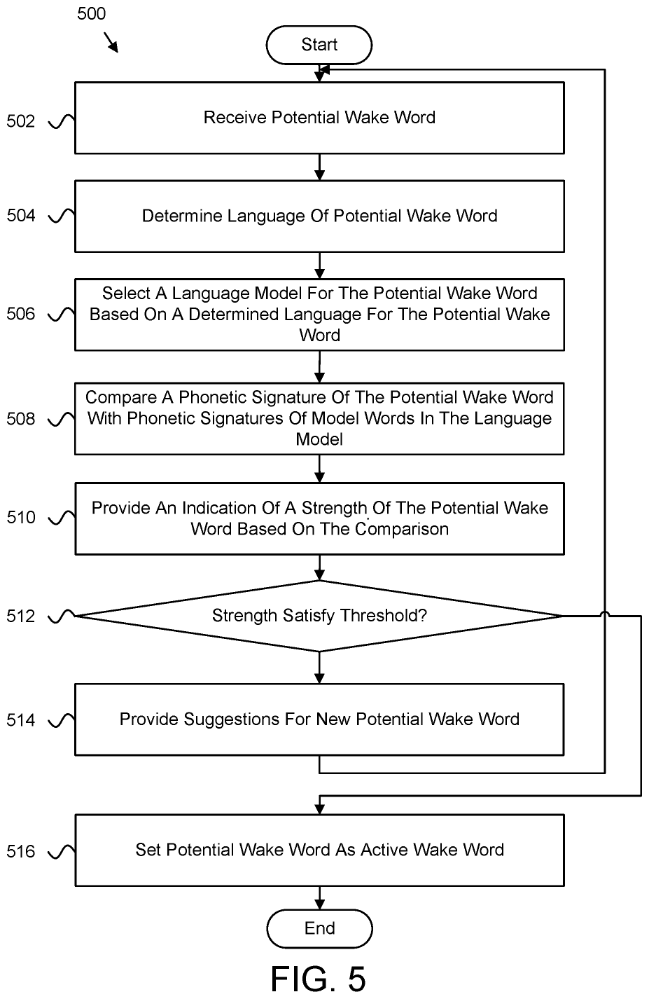

FIG. 5 is a schematic flow chart diagram illustrating one embodiment of another method 500 for determining wake word strength. In one embodiment, the method 500 begins and receives 502 a potential wake word. The method 500, in further embodiments, determines 504 a language of the potential wake word. In one embodiment, the method 500 selects 506 a language model for the potential wake word based on a determined language for the potential wake word.

In certain embodiments, the method 500 compares 508 a phonetic signature of the potential wake word with phonetic signatures of model words in the language model. In further embodiments, the method 500 provides 510 an indication of a strength of the potential wake word based on the comparison.

In one embodiment, if the method 500 determines 512 that the strength of the potential wake word satisfy the threshold strength, the method 500 sets 516 the potential wake word as the active wake word for the device, and the method 500 ends. Otherwise, the method 500 provides 514 suggestions for new potential wake words and continues to receive 502 potential wake words. In one embodiment, the model selection module 202, the signature module 204, the indicator module 206, the receiving module 302, the language determination module 304, the settings module 306, and the suggestion module 308 perform the various steps of the method 500.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus, comprising:
a processor; and
a memory that stores code executable by the processor to:
select a language model for a potential wake word based on a determined language for the potential wake word, the potential wake word intended to activate a device;
compare a phonetic signature of the potential wake word with phonetic signatures of model words in the language model to determine a likelihood of occurrence of one or more of the model words based on the potential wake word; and
provide an indication of a strength of the potential wake word based on the likelihood of occurrence of one or more of the model words.

2. The apparatus of claim 1, wherein the code is further executable by the processor to receive the potential wake word while the device is in a setup mode.

3. The apparatus of claim 2, wherein the potential wake word comprises a spoken word or phrase from a user that is received via a microphone.

4. The apparatus of claim 1, wherein the code is further executable by the processor to determine the language for the potential wake word based on a language analysis of the potential wake word.

5. The apparatus of claim 4, wherein the code is further executable by the processor to select a general language model as the language model in response to the language of the potential wake word not being determinable.

6. The apparatus of claim 1, wherein the strength of the potential wake word comprises a quantitative value determined based on a frequency of occurrence of one or more of the model words that are phonetically similar to the potential wake word, the quantitative value comprising one or more of a score, a rank, and a percentage.

7. The apparatus of claim 1, wherein the provided indication comprises an audio indication of the strength of the potential wake word, the audio indication comprising one of an audio message and a number of beeps.

8. The apparatus of claim 1, wherein the provided indication comprises a visual indication of the strength of the potential wake word, the visual indication comprising one or more of presenting a text message and/or an image on a display and/or presenting a light pattern and/or a light color using one or more lights on the device.

9. The apparatus of claim 1, wherein the code is further executable by the processor to set the potential wake word as an active wake word for the device in response to the strength of the potential wake word satisfying a threshold strength.

10. The apparatus of claim 1, wherein the code is further executable by the processor to prevent the potential wake word from being used as an active wake word for the device in response to a strength of the potential wake word not satisfying a threshold strength.

11. The apparatus of claim 10, wherein the code is further executable by the processor to allow the potential wake word to be used as an active wake word for the device in response to receiving input from a user to override prevention of the use of the potential wake word.

12. The apparatus of claim 1, wherein the code is further executable by the processor to determine and provide one or more suggestions for different potential wake words based on the potential wake word and one or more of the model words that are likely to occur based on the potential wake word.

13. The apparatus of claim 1, wherein the code is further executable by the processor to provide the one or more model words that are likely to occur based on the potential wake word.

14. A method, comprising:
selecting, by a processor, a language model for a potential wake word based on a determined language for the potential wake word, the potential wake word intended to activate a device;
comparing a phonetic signature of the potential wake word with phonetic signatures of model words in the language model to determine a likelihood of occurrence of one or more of the model words based on the potential wake word; and
providing an indication of a strength of the potential wake word based on the likelihood of occurrence of one or more of the model words.

15. The method of claim 14, further comprising receiving the potential wake word while the device is in a setup mode, the potential wake word comprising a spoken word or phrase from a user that is received via a microphone.

16. The method of claim 14, further comprising determining the language for the potential wake word based on a language analysis of the potential wake word, and in response to the language of the potential wake word not being determinable, selecting a general language model as the language model.

17. The method of claim 14, wherein the strength of the potential wake word comprises a quantitative value determined based on a frequency of occurrence of one or more of the model words that are phonetically similar to the potential wake word, the quantitative value comprising one or more of a score, a rank, and a percentage.

18. The method of claim 14, further comprising setting the potential wake word as an active wake word for the device in response to the strength of the potential wake word satisfying a threshold strength.

19. The method of claim 14, further comprising determining and providing one or more suggestions for different potential wake words based on the potential wake word and one or more of the model words that are likely to occur based on the potential wake word.

20. A computer program product, comprising a computer readable storage medium having program instructions embodied therewith, the program instructions executable by a processor to cause the processor to:
select a language model for a potential wake word based on a determined language for the potential wake word, the potential wake word intended to activate a device;
compare a phonetic signature of the potential wake word with phonetic signatures of model words in the language model to determine a likelihood of occurrence of one or more of the model words based on the potential wake word; and
provide an indication of a strength of the potential wake word based on the likelihood of occurrence of one or more of the model words.
